(19) United States
(12) Patent Application Publication
(10) Pub. No.: US 2012/0157356 A1
(43) Pub. Date: Jun. 21, 2012

(54) Hydraulic fracturing with slick water from dry blends

(75) Inventors: Jeffrey C. Dawson, Conroe, TX (US); Derek J. Handke, Blanchard, OK (US); Bradford A. Holms, Katy, TX (US); David L. Holcomb, Golden, CO (US)

(73) Assignee: FRAC TECH SERVICES LLC, Cisco, TX (US)

(21) Appl. No.: 12/972,595

(22) Filed: Dec. 20, 2010

(51) Int. Cl. C09K 8/68

(52) U.S. Cl. 507/219; 507/225

(57) ABSTRACT

A “slick water” fluid for hydraulic fracturing of wells is provided that is mixed by adding solid polymer and solid additives to water. The fluid may be batch mixed or mixed in a continuous process using standard blending equipment. Components are selected that are environmentally preferred. Lower cost and environmental benefits are realized.

### BACKGROUND OF INVENTION

1. Field of the Invention

This invention relates to the process of hydraulic fracturing of wells. More particularly, a mixture of polymer powder and additive powder is added to water at a well site to lower cost of fracturing treatments and provide an environmentally preferred “slick water” fluid that can be dispersed with conventional mixing equipment.

2. Description of Related Art

Low concentrations of polymer are added to water used in hydraulic fracturing of wells to decrease the pressure losses (by decreasing turbulence) as fluid is pumped. Water-based fracturing fluids containing the polymer are called “slick water.” Slick-water fracturing of oil and gas wells is conducted by pumping at high pressures and high velocities through a vertical and, usually, a horizontal section of a well. The well contains well casing and, in some wells, tubing inside the casing. Perforations or ports in the casing are adjacent to targeted intervals of subterranean formations containing a hydrocarbon. Hydraulic pressure exerted on the formation causes the formation to fracture, creating an extensive fracture network. Most often these formations have minimal permeability and include sandstone, shale or coals. Once the fracture or crack is initiated, pumping is continued, allowing the fracture to propagate. Once the fracture has gained sufficient fracture width, proppant is added to the fluid and is transported to the fracture system, partially filling the fracture network. After the desired amount of proppant is placed in the fracture, additional water-based fluid is pumped to flush the casing of any proppant that may have settled in the casing. On completion of the fracturing process, the well is opened, allowing a portion of the fluid to be recovered. As the pressure is relieved, the fracture closes onto the proppant, creating a conductive pathway needed to accelerate oil and gas recovery from the formation.

In slick-water fracturing of gas shales, multiple fracturing treatments are sequentially performed on horizontal wells, often using casing plugs to separate the fracturing treatments. Using this method, the initial fracturing treatment is conducted near the toe of the well. The fracturing treatments are then conducted sequentially moving toward the heel of the horizontal section. Each fracture treatment is defined as a “stage” and these wells can be treated with five to forty stages, using from about one million to as much as fifteen million gallons of water.

The water-based fluid can contain polymer and multiple chemical additives. The additives may include biocide, scale inhibitor, clay control additive, oxygen scavenger and surfactant that assists fluid recovery. To keep the fracturing treatments affordable, only minimal amounts of these additives are used. Each additive is normally liquid-based and is metered separately into the treatment fluid and mixed with water and other additives in the blender. The blender includes a 5- to 15-barrel tub with agitation devices. The additive concentrations are commonly expressed as gallons of additive per 1000 gallons of water (abbreviated as gpt). The additives typically are composed of a chemical that provides the desired function such as scale inhibition and a solvent, commonly water, alcohol or oil. The polymer in slick-water fluids provides friction reduction during pumping of the fluid into a well.

Friction reducers are commonly delivered to a well site as invert polymer emulsions (oil external) dispersions of polyacrylamide copolymers such as 30% anionic polyacrylamide. Typical loadings range from 0.1 to 1.0 gpt and the polymer activity typically ranges from 20% to 40% (by wt). Addition of friction reducers to the water allows the fluid to be pumped at higher velocities with the same surface pressure by maintaining laminar flow at the higher flow rates, minimizing pressure losses. The polymer emulsions have disadvantages such as limited shelf life and cold weather intolerance. They are also intolerant to small amounts of water, which can cause the polymer to invert and swell to form lumps that can plug transfer hoses and pumps. Also, on completion of the treatment, the transfer hoses and pumps are normally flushed with oil to remove most of the friction reducer. However, it is common that polymer residue will adhere to the hoses' interior surface. If these hoses set for extended times between jobs, that residual polymer will dry out and, on the next job, will break free from the hose surface to again plug pumps.

An important additive to slick-water fluids is the biocide. Most water used for fracturing treatment comes from rivers, creeks, lakes, ponds and recovered water-based treating fluids. Often, these waters are laden with aerobic, acid-producing bacteria that can cause extensive corrosion of the well tubulars, down-hole tools and submersible pumps. Other common aerobic bacteria are the slime-producing microorganisms that can impair critical oil and gas flow paths in the formation or fracture system. There are also anaerobic bacteria such as sulfate-reducing bacteria that can produce poisonous hydrogen sulfide gas and sour the well. To prevent extensive bacteria population growth, biocides are commonly added to the treatment fluid. Examples of these biocides include glutaraldehyde, tetrakishydroxymethyl phosphonium sulfate (THPS), tetrahydro-3,5-dimethyl-2H-1,3,5-thiadiazine-2-thione (Dazomet), and quaternary surfactants such as didecyl dimethyl ammonium chloride, or mixtures of these biocides. These are typically used at 0.1 to 0.5 gpt, but can be used at higher loadings, depending of the severity of the bacteria problem. Other types of biocides include oxidizing agents such as sodium chlorite (bleach) chlorine dioxide and hypochlorous acid. The disadvantage of these agents is their limited freeze protection and shelf life. Also, because of their toxicity, any spills require extensive remediation to prevent their contaminating fresh waters containing aquatic life.

Another additive often needed is the scale inhibitor used to prevent insoluble, inorganic scales from plugging critical fluid pathways in the formation, proppant pack or tubulars. Often times, there is an incompatibility between the natural formation water and the treatment water that induces scale formation. There are two common categories of inhibitor: polyacrylates and polyphosphates or phosphonates. These additives are commonly used at loadings ranging from 0.1 to 2.0 gpt, depending on the scaling tendency of the water. These additives also suffer from freezing and shelf life limitations.

Clay control additives are also commonly employed to minimize water interactions with clays that exist in the formation. The most common clay control additive is 2% to 5% potassium chloride. This is equivalent to 166 lb to 415 lb of salt per thousand gallons of water. Because of these high concentrations, often times, much lower loadings of mono-quaternary ammonium salts are pumped instead of the salt. These typically range from 0.12 to 1.0 gpt and prevent clays such as smectite and mixed layered clays from swelling or migrating, causing the plugging of essential fluid pathways. A disadvantage of using these chemicals in liquid form is their biocidal efficacy, so that it would be necessary to remediate spills to prevent contamination of fresh water sources and aquatic life.

Two other additives used at times are oxygen scavengers and flow-back additives. The oxygen scavengers are designed to oxidize by reacting with molecular oxygen dissolved in the fracturing fluid. This process removes the molecular oxygen to prevent down-hole corrosion. These additives are typically sulfite salts catalyzed with nickel or cobalt complexes and are usually pumped at about 0.1 gpt. Flow-back additives are normally surfactant blends that can contain nonionic surfactants, silicone-based surfactants or fluorosurfactants. These can also be mixtures of these additives. Recently, micro-emulsions containing terpenes, water, oxygenated solvents and non-ionic surfactants, have also been used as effective flow-back additive, as described in U.S. Pat. No. 7,380,606. The purpose of these additives is to reduce formation and proppant pack pressure drop, allowing more of the treating fluid to be recovered after the treatment. Recovering more fluid often improves the rate of oil and gas recovery. The flow-back additives are normally pumped between 0.25 and 1.0 gpt.

Liquid-based additives are formulated so that small volumes of the product are easily metered and mixed in the treating fluid. However, there are several disadvantages to these liquid-based additives. As mentioned above, they can have limited shelf life, be intolerant to cold temperatures and be difficult to contain and clean-up if spilled on the ground. Because each additive is pumped separately, each additive must have its own dedicated pump and its own vessel, transfer hoses, metering and monitoring system. Pumping each additive individually causes additional complexity to the treatment. Also, large volumes of these additives are required for larger slick-water treatments. Management of the additive containers, both the full containers and the empty ones, becomes a logistical constraint, and adds additional complexity to the treatment. Furthermore, the cost of the solvents and the freight costs for the solvents add unnecessary costs to the treatment.

To simplify this process, the additives could be blended together so that only one product needs metering, monitoring and pumping. Unfortunately, it is not practical to blend all the liquid additives together, because of their incompatibility. For example, aqueous base additives mixed with the liquid friction reducers will immediately clump and become impossible to pump and will offer little, if any, friction reduction. Also, the mixture of the anionic scale inhibitor and cationic clay stabilizer could cause the mixture to become insoluble.

It has long been known to mix fracturing fluids by adding dry polymer to water. U.S. Pat. No. 5,190,374 discloses adding powdered polymer to water in an axial flow mixer having high mixing energy. The polymer particles may be treated with a hydration-delaying coating and may be sprayed with water for wetting. U.S. Pat. No. 5,947,596 discloses a system for mixing dry powder, which may be polymer, and water. The powder is subjected to a high-shear temporarily and the fluid enters a holding tank. U.S. Pat. No. 5,981,446 discloses a dry blend of polysaccharide polymer, a cross-linking agent and a base to create conditions for cross-linking. Other additives blended and injected as part of the dry blend are not disclosed. U.S. Pat. No. 6,642,351 discloses methods for dispersing polyacrylamide particles in water by forming an airborne stream of particles and contacting the airborne stream with a stream of water.

U.S. Pat. App. Pub. 2006/0058198 pertains to cross-linked fluids and also discloses a dry blend of cross-linker and delay agent with polymer that may include additives The '198 application describes the use of a solid crosslinking and delay additive to be used with pre-hydrated polymeric fluid. In contrast, the friction reducing polymer of the present invention is part of the dry-blend composition. U.S. Pat. App. Pub. 2009/0023614 provides a good review of the problems of hydrating polymers in water-based fluids and how industry has dealt with the problems. Complex polymer hydration equipment has been developed for polymer hydration.

What is needed is a method to mix fluids at a well site from a dry blend of chemicals that are selected and blended for a particular well treatment using standard mixing apparatus and methods. It should be possible to pre-blend the materials and transport them to the well as a mixture and use a standard blender. The additives should be environmentally preferred compared with other chemicals having the same function.

### BRIEF SUMMARY OF THE INVENTION

Method for hydraulic fracturing a well with slick water by mixing dry chemicals in water is provided. The chemicals consist of a polymer and additives. The combination of powdered chemicals with the polymer allows the polymer to disperse in water using standard mixing equipment and techniques. Environmentally preferred additives are provided.

### BRIEF DESCRIPTION OF THE SEVERAL VIEWS OF THE DRAWING(S)

FIG. 1 is a sketch of a first embodiment of an arrangement of equipment used to mix and pump fluid containing powdered polymer and the dry blend additives disclosed herein.

FIG. 2 is a sketch of a second embodiment of an arrangement of equipment used to mix and pump fluid containing powdered polymer and the dry blend additives disclosed herein.

FIG. 3 is a plot of pressure drop in a flow loop as slick water made with polyacrylamide is flowed through the loop, expressed as percent reduction in pressure drop compared with water.

FIG. 4 is a plot of pressure drop in a flow loop as slick water made with guar and polyacrylamide and added to water at different temperatures is flowed through the loop, expressed as percent reduction in pressure drop compared with water.

### DETAILED DESCRIPTION OF THE INVENTION

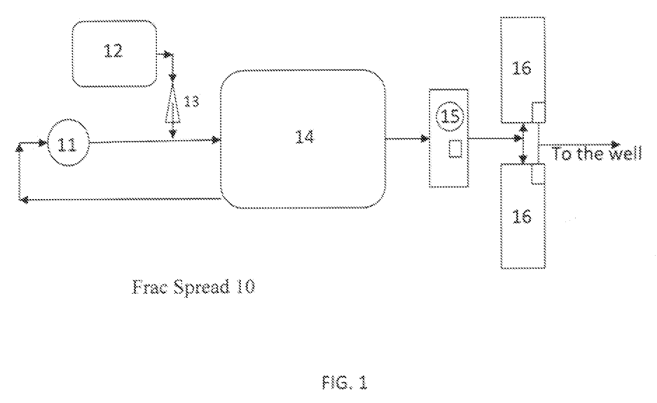

Referring to FIG. 1, a sketch of “frac spread” 10 using batch mixing is shown. Fluid is drawn from tank 14 and pumped through pump 11 at a selected rate. Mixed powder is stored in container 12 and metered by either a volumetric or mass-driven metering system. The powder may be dropped through standard eductor system 13 or any device that provides both powder dispersion and mixing (shear) on the fluid upon contact with the water. Once the powder is mixed with the water, this fluid is circulated back into holding tank 13. When all the powder has been added to the water to make-up the treating fluid in tank 14, contents of tank 14 are pulled from holding tank 14 through blender assembly 15 to be mixed with proppant (when the treatment requires proppant). This fluid is then pumped to high-pressure pumps 16 and the pressurized fluid is pumped into a well (not shown).

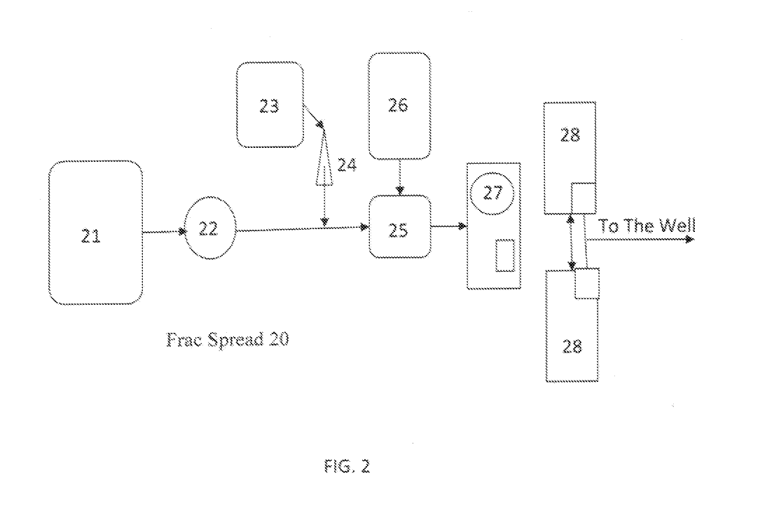

Referring to FIG. 2, a sketch of alternate “frac spread” 20 using “on-the-fly” or continuous mixing is shown. Water in tank 21 is pulled through pump 22 at a selected rate. Mixed powder is stored in vessel 23 and metered through eductor 24 or any device that provides both powder dispersion and mixing with water, as explained above. Fluid is then pumped into holding tank 25 to allow a short residence time for polymer hydration. The stream through educator 24 may be a slip stream from the main water supply. The remaining water supply may be represented as in tank 26. Water from supply 26 may be added to the slip stream in tank (or mixer) 25. Fluid then is directed to blender 27, where proppant may be added. The mixed fluid then goes to high-pressure pumps 28 for injection into a well. Alternatively, mixed powder may be metered through eductor 24 into blender 27 under conditions favorable to rapid dispersal and hydration.

Using apparatus such as illustrated in FIG. 1 and FIG. 2, multiple components of fracturing fluids may added to water as dry, free-flowing powders to form “slick water.” The polymer concentration is less than 7 ppt in slick water, as the term is defined herein. It has been discovered that the polymer used in slick water and other additives needed in the fluid can be mixed as dry powders, handled and added to water without incompatibility caused by reactions. Furthermore, on mixing with the water, the mixture of the additives and powdered polyacrylamide or other polymer friction reducer disperses without clumping. Without the inclusion of these additives with the polymer, the polymer forms clumps or “fish-eyes,” causing an increase in friction pressure and possible perforation, formation or proppant pack damage. A laboratory experiment demonstrated that a minimum amount of powdered additive is required to significantly decrease or eliminate clumping. With an overhead mixer set at 1100 rpm, a mixture of differing amounts of powdered additive and polymer was dumped in at once. With a scale of 1 to 5, 5 being the most clumps and 1 being the least,

Test 1. 0.60 g, of 50% Guar/50% Choline Chloride (45%): No visible clumps or particles. (Score of 1)

Test 2. 0.33 g, of 90% Guar/10% Choline Chloride (45%): Six large clumps, around 3 mm in size. (Score of 5)

Test 3. 0.43 g, of 70% Guar/30% Choline Chloride (45%): No visible clumps or particles. (Score of 1)

The tests show that when both 50% and 30% Choline Chloride are used in a mixture with the polymer, the polymer disperses without clumping. However, at 10% choline chloride, significant clumping .does occur. Therefore, to avoid clumping when mixing the polymer in water to form slick water, the amount of powdered additive with the polymer is preferably greater than 10%, is more preferably greater than 20%, and most preferably is 30% or greater. These amounts can be achieved in the mixing of slick-water, when the amount of polymer is relatively small compared with normally viscous linear or cross-linked fluids used in industry.

The particle size of the various additives can range from 20 mesh to 140 mesh (0.841 mm to 0.105 mm). However, it is preferable that each component have nearly the same apparent density and particle size to prevent segregation of the blend during storage and transport to the well site. Also, the powder must be flowable (low angle of repose), with the flow measured as the drainage time through a wide-mouth funnel. Examples of the flowability of dry components that can be used in fracturing fluids are shown in Table 1. Ammonium persulfate is a breaker used on guar based polymer solutions and is often added as a dry additive to the treating fluid. This chart shows the time to be 0.2 minutes. In contrast, the powdered mixture with 45% choline chloride on silica drained from the funnel in 0.12 minutes, faster than the ammonium persulfate commonly used as a dry additive. Furthermore, guar gum is now being added to the treating fluid in dry form rather than as oil-based slurries as defined, as an example, in U.S. Pat. No. 7,104,328. In this case, the drainage time for the guar gum was 2.92 minutes or 24.3 times slower than the blend of the invention, but even with such poor flowability, blending dry guar gum in the treating fluid is applicable. If guar gum-decreased flowability is suitable for blending, then the powdered dry-blend of the current invention is applicable. Finally, to demonstrate the range of dry additive flowability, potassium chloride (KCl) was also tested and found to drain in 0.05 min or 2.4 times faster than the dry-blend of the invention.

TABLE 1

| Dry Components | Time in Minutes* |
|---|---|
| Powdered Mixture w/100% Choline Chloride | >5 |
| Guar Gum | 2.92 |
| Ammonium Persulfate | 0.2 |
| Powdered Mixture w/45% choline chloride | 0.12 |
| on silica | |
| Potassium Chloride | 0.05 |

The mixture referred to in the first line (Powdered Mixture/100% Choline Chloride) contained the following components:
30% Anionic Polyacrylamide=18%
Dazomet=11%
Sodium Polyaspartate=2%
Choline Chloride=69%
   This mixtures flowed too slowly because the pure (100%) choline chloride is too sticky. Consequently, 45% choline chloride on silica was used for better dry flow characteristics. That composition reported on line 4 as Powdered Mixture/45% Choline Chloride on silica is shown below and differs from above to account for the silica.
30% Anionic Polyacrylamide=10%
Dazomet=6%
Sodium Polyaspartate=1%
45% Choline Chloride on silica=83%.

Each fracturing treatment will utilize its own unique formulation of additives. The blend may be made at a well site, but preferably is made remotely and transported to the well site as solid powder. Each powdered mixture must be custom blended for the treatment and the ratio and composition of the blend will change for each treatment. Furthermore, the powdered additives should be selected to be environmentally acceptable chemicals. Then, if spilled and the contents remain dry, the clean-up can be easily accomplished by removing the dry additive with only a small amount of soil. The environmentally acceptable or preferred chemicals arc those having lower toxicity as measured by LD₅₀ numbers, less persistence, and that degrade rapidly and do not accumulate in living animals. The LD₅₀ number is a measure of acute toxicity and it is used to define the dose of a toxic substance required to kill half the members of a tested population after a specified test duration. It is normally expressed as mass of substance, usually mg, per kilogram of body mass. Table 2 below shows the LD₅₀ numbers for the various additives used as additives for slick-water fracturing. The components having one asterisk are those used in the current invention. The components having two asterisks represent common current liquid additives. The larger the LD₅₀ number, the less toxic the substance. Table 2 shows that all dry-blend components are less toxic than the current liquid additives except for Dazomet. However, the Dazomet biocide has a very short persistence in the environment, improving its environmental acceptance. The Flopam AN-934 is manufactured by SNF and the Criterion products are made by Kemira. The FRW-200 is supplied by Frac Tech Services.

TABLE 2

| | Acute Oral | |
|---|---|---|
| | Effect | |
| Product | LD50 Rats | Function |
| Guar Gum* | 6,770 | Friction Reducer |
| Flopam AN 934* | 5,000 | Friction Reducer |
| FRW-200** | 5,000 | Friction Reducer |
| Dazomet* | 519 | Biocide |
| PCMX* | 3,830 | Biocide |
| ICI-3240 (25% Dazomet)** | 1,650 | Biocide |
| Sodium Thiosulfate* | 2,890 | Oxygen Scavenger |
| Sodium Erythorbate* | 5,000 | Oxygen Scavenger |
| Sodium Bisulfite** | 1,131 | Oxygen Scavenger |
| Sodium Polyaspartate* | 10,000 | Scale Inhibitor |
| Criterion 2005N** | 5,000 | Scale Inhibitor |
| Criterion 2605** | 5,000 | Scale Inhibitor |
| Choline Chloride* | 3,400 | Clay Stabilizer |
| Tetramethylammonium Chloride** | 94 | Clay Stabilizer |

*chemical components considered for use in the dry-blend.
**chemical components currently used in liquid additives.

It has been discovered that a suitable dry blend can be composed of the following polymers and additives to offer the necessary functionality. (Concentration in lb/1000 gal may be abbreviated as ppt in the following paragraphs.)

TABLE 3

| | | Concentration |
|---|---|---|
| Product | Function | (lb/1000 gal) |
| 30% Acrylate-Acrylamide | Friction Reduction | 0.75 to 2.5 |
| Copolymer | | |
| Guar Gum | Friction Reduction | 3.0 to 8.0 |
| Dazomet* | Biocide | 0.58 to 2.32 |
| Sodium polyaspartate | Scale Inhibitor | 0.04 to 0.76 |
| 45% Choline Chloride on | Clay Control | 2.61 to 10.42 |
| Silica | | |
| Sodium Thiosulfate | Oxygen Scavenger | 0.24 to 1.20 |
| Surfactant | Flow-back Additive | 0.21 to 0.82 |

*Dazomet is a trade name for 2,5-dimethyl-1,3,5-thiadiazinane-2-thione, sold by Buckman Laboratories. Other chemicals are well known in the industry.

Normally, not all the additives are used in each blend. For example, the polyacrylamide and guar gum are not normally used together as friction reducers, but in certain instances, both may be appropriate to provide the degree of friction reduction needed. In other cases, the treatment may not utilize oxygen scavengers or flow-back additive. In almost all cases, friction reducer, biocide and clay control are needed, and it has been discovered that they may be blended together as dry solids with the powdered polymers and dispersed in water-based fracturing fluid using conventional equipment such as shown in FIGS. 1 and 2. In other instances, the dry blend may contain all or most of the dry additives listed in Table 3. In addition to the dry blend of polymer and, additives added as described above, solid or liquid additive may be added in a blender (15 of FIG. 1 or 27 of FIG. 2), using usual industry procedures, when the treatment fluid may need additional additive, such as additional biocide.

### EXAMPLE 1

A blend was prepared with the following composition:

| | Amount (% of |
|---|---|
| Product | total, by weight) |
| 30% Anionic Polyacrylamide (PAM) | 9.82 |
| Dazomet | 9.26 |
| Sodium Polyaspartate | 1.20 |
| Sodium Thiosulfate | 7.90 |
| 45% Choline Chloride on Silica | 71.83 |

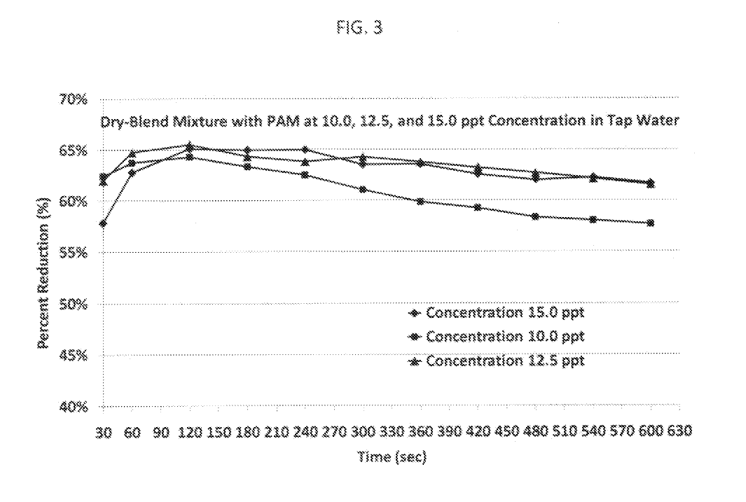

This blend was dissolved in water at concentrations equivalent to 10, 12.5 and 15 ppt gal tap water. (The expected concentration for the treatment was 12.5 ppt, but 20% less (10 ppt) and 20% more (15 ppt) were evaluated. This tested variance exceeds normal field pumping variations.) The fluid was then pumped through a flow loop having a rube diameter of 0.4064 cm, length of 16.46 m. The flow rate was 2.90 gal/min and the pressure drop near the inlet and outlet were recorded. The friction pressure was calculated and compared to tap water. The results are expressed as the percent reduction as compared to water and shown in the FIG. 3.

These data show that even with 20% variance in concentration potentially caused by metering problems during the treatment, the powdered blend is robust and can still provide adequate friction reduction.

### EXAMPLE 2

Two dry blend compositions were prepared differing in the friction reducer with the blends shown in the following composition:

| | PAM Based | Guar Based |
|---|---|---|
| Component | Blend (%) | Blend (%) |
| 30% Anionic Polyacrylamide | 10 | 0 |
| Guar Gum | 0 | 26 |
| Dazomet | 6 | 5 |
| Polyaspartate | 1 | 1 |
| 45% Choline Chloride on Silica | 83 | 67 |

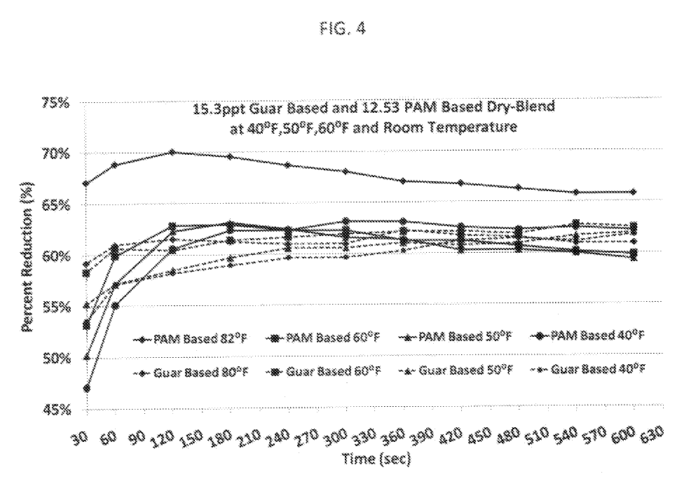

One composition used 1.23 ppt polyacrylamide (PAM) in the blend run at 12.53 ppt and the other used 4.0 ppt guar gum and the blend run at 15.3 ppt. The blends were also run on the flow loop described in Example 1 using various temperatures of water to evaluate the hydration rate effects on friction reduction. The results, again expressed as percent reduction as compared to tap water, are shown in FIG. 4. One unexpected advantage of the polymer-additive blend is that the uniformly blended powder tends to disperse better when mixed with water and prevent polymer clumping compared to the polymer alone.

These data suggest that the guar gum and polyacrylamide-based blends provide comparable friction reduction. The exception in the data is the polyacrylamide-blend at 82° F., which shows better friction reduction. It also suggests that the guar is more stable over time with shearing. The guar gum based blend curves remained flat through the test whereas the polyacrylamide blends show slight loss in efficiency over time.

If batch mix operations (illustrated in FIG. 1) are used so that time of mixing is not critical, particle size of the components used in the blend can be as large as 18 mesh (1.0 mm). However, if the mixing is to be based on a continuous mix process (FIG. 2), timing becomes more critical, requiring that the polymeric components disperse and begin hydration prior to reaching the well head. In this case, the particle size of the components preferably is 40 mesh (0.420 mm) or smaller, but more preferably 80 mesh (0.177 mm) or smaller. Also, it is preferred that the particle size and the apparent density of all the components be about the same (to minimize segregation during shipping and storage). Apparent densities of selected commercial components, as measured by measuring volume increase of a dispersion of a known weight of solid in mineral oil, are shown in Table 2. A dry blend preferably will be formed of components for each function in a fracturing fluid having apparent densities and particle sizes matched to the best extent possible. Inert solids, such as fumed silica, may be combined with active ingredients to form solid particles having a preferred density.

TABLE 2

| Product | Apparent Density (g/ml) |
|---|---|
| Flopam AN 934 Fines | 1.176 |
| PfP 4045 | 1.176 |
| Dazomet 99% | 1.111 |
| Sodium Thiosulfate | 1.667 |
| BIO-ADD 1060 | 1.111 |
| Polyaspartic Acid 99% | 0.870 |

Polyacrylamide (PAM) powders capable of providing friction reduction at concentrations of 0.5 to 2.0 ppt are high molecular weight polymers ranging from 3 to 20 million g/mole. They are also very soluble in water and, if smaller than 20 to 40 mesh, can clump together, forming localized gel domains that can plug pumps. The larger size is predominantly sold to prevent clumping, but it requires longer hydration times.

Another attribute of the powder mixture has been discovered when testing the effectiveness of the Dazomet biocide.

### EXAMPLE 3

In this example, the biocidal efficacy of the powder mixtures was tested. The bacteria types tested are as follows:
Bacteria
Pseudomonas aeruginosa
Staphylococcus aureus
Bacillus cereus
Klebsiella pneumonia

A mixture was evaluated using 0.184 g of the dry mixture composed of the following formulation based on weight percentages:

Guar gum—39%

Dazomet Biocide—15%

Polyaspartate—1%

Choline Chloride—20%

A second blended product containing 0.158 g of the mixture made of the following composition:

30% Anionic polyacrylamide—17%

Dazomet—27%

Polyaspartate—2%

Choline Chloride—36%

Standard testing procedures were used. The data showed that the biocide used in the both the guar-based and PAM-based blends were comparable or better than test just having the Dazomet and the blends had much better control of bacteria than the Control test not having any biocide. Furthermore, the data showed that the performance of the PAM-based blend out-performed the Dazomat alone, suggesting the mixture has additional biocidal tendencies beyond just the Dazomet biocide. Also, although guar gum is a good nutrient in the mixture, longer term inoculations showed good control over bacteria infestations.

Because of the large amount of potassium chloride needed to make up 2% to 5% KCl in the large volumes of slick-water fracturing fluids, many slick-water fracturing treatments in gas shales have been performed successfully without KCl. In those reservoirs that have clay sensitivity problems, the KCl substitutes have worked to satisfaction. The KCl substitutes are commonly mono-quaternary ammonium halides, such as those defined in U.S. Pat. Nos. 5,197,544 and 4,977,962, which are hereby incorporated by reference herein for all purposes. The most common is tetramethyl ammonium chloride. Typical concentrations range from 0.25 to 2.0 gpt and most often range from 0.5 to 1.0 gpt.

Shelf life of solid mixtures disclosed herein has also been investigated. Mixtures containing Dazomet biocide and polyacrylamide-based friction reducers are limited to about 7 days at room temperature. Hydration of the polymer may be delayed if the mixture is used after its shelf life. The limitation can be managed by several different strategies. First, the product can be custom blended and used in the treating fluid within a couple of days and before reactions affect the friction reduction. This requires storage of the blended composition in cool places to minimize temperature acceleration of the decomposition and crosslinking process. Another strategy is to substitute a non-decomposing biocide in place of Dazomet. For example, methyl or benzyl isothiazolinone dried on a solid substrate appear to be more effective at killing bacteria than Dazomet under some conditions. Another applicable biocide for this substitution is the tetrakis hydroxymethyl phosphonium sulfate (THPS). Replacement of the Dazomet with these biocides will prevent the polymer intolerance while also effectively managing bacteria growth. The only disadvantage of these biocides is their higher cost.

In addition to substituting the biocide, the polyacrylamide friction reducer can also be substituted with any dry powder, water-soluble polymer capable of providing friction reduction when pumping the treating fluid. These include guar gum, hydroxypropyl guar, carboxymethylhydroxypropyl guar, carboxymethyl guar, hydroxyethyl cellulose, carboxymethylhydroxylethyl cellulose, locust bean gum, xanthan gum, wellan gum, starches, polyethyleneoxide. This will also provide needed friction reduction without suffering from the intolerance to Dazomet decomposition, but will often require higher percentages of polymer in the blend than the polyacrylamide. Finally, mixtures of the poyacrylamide and another friction reducing polymer can be blended together to reduce the effect of the incompatibility. For example, 25% (by wt) 30% anionic polyacrylamide and 75% (by wt) guar gum can be mixed with good compatibility and friction pressure reduction. The last strategy useful in resolving the Dazomet-polyacrylamide incompatibility is to exclude the Dazomet from the mixture and pump it separately as either a liquid or a solid powder additive. The preferred method is to pump the biocide as a supplemental liquid additive to minimize operational complexity. Pumping the biocide provides easier handling, metering and mixing, rather than metering the mixture composition and the solid biocide separately.

### EXAMPLE 4

A well test using a dry-blend composition was conducted on a horizontally-drilled well in the Eagle Ford Shale of south Texas. The fracturing treatment was pumped down the well casing composed of P-110 steel alloy 5½ inch in diameter. The total well depth was 11,500 ft with the vertical depth being 7,200 ft. One stage of a multi-stage fracturing program utilized the dry-blended composition. This well employed the traditional liquid additives through the early part of the treatment (as a reference) and switched to the new dry composition midway through the treatment. The composition of the liquid additives and loadings as well as the dry-blend composition and loadings is shown in the Table 3

TABLE 3

| | Liquid Additive | Equivalent | Solid Additive |
|---|---|---|---|
| | Loading | Solid | Loading |
| Liquid Additives | (gpt)* | Additives | (ppt)** |
| 30% Anionic PAM | 0.5 | Guar Gum | 4.00 |
| invert emulsion | | | |
| Dazomet Biocide | 0.4 | Dazomet powder | 0.93 |
| Polyacrylate Scale | 0.1 | Polyaspartate | 0.08 |
| Inhibitor | | | |
| Proprietary Quaternary | 0.5 | 45% Choline | 5.21 |
| Ammonium Salt for | | Chloride | |
| Clay Control | | on Silica | |

The metering and logistics management of the dry-blend composition was necessary for only one product, whereas the liquid system required the metering and logistical management of four additives, complicating the fracturing process. The treatment loading of the dry-blend composition was 10.21 lb per 1000 gal of treating fluid. The fluid was initially pumped at a rate of 100 bbl/min, injecting a total of 18,092 bbl of fluid, using 1,610 bbl for the pad, 14,360 bbl for the slick-water portion and 340 bbl for flush. About a third of the slick-water portion of the treatment utilized the dry-blend composition. The treatment also placed 35 ton of 100 mesh sand, 72 ton of 40/70 mesh sand and 25 ton of 20/40 mesh sand in the fracture system.

The powder was metered and mixed in the water using a trailer containing a pump, auger powder feeder, eductor with a pipe constriction causing a Venturi effect or pressure drop (vacuum) at the eductor and a storage tank to give about a minute of residence time, as illustrated in FIG. 2. The flow rate of the slip stream that provided optimum vacuum on the eductor system was 255 gal/min (6 bbl/min).

The hydration unit used normally has a capacity of 180 bbl and is used to allow higher loadings of guar gum-based fluids to adequately hydrate before crosslinking or injection into the well. However, the hydration unit was used in this test to proportion the 6 bbl/min of fluid containing all the additives with the other 94 bbls of water needed to achieve 100 bbl/min prior to pumping the diluted fluid into two blenders used to meter and mix the sand with the fluid.

After discharging from the two blenders, the fluid entered a manifold system and was finally injected into the well at high rate and pressure. Prior to addition of the dry-blend composition, the surface treating pressure was averaging about 8,900 psi at 100 bbl/min. Once all the liquid additives were terminated, relying solely on the dry-blend composition, the pressure increased to about 9,000 psi and the rate decreased to about 94 bbl/min. The test verified that the dry-blend composition could be metered; mixed and pumped at about the same rate and pressure to replace the existing liquid additives.

It is understood that modifications to the invention may be made as might occur to one skilled in the field of the invention within the scope of the appended claims. All embodiments contemplated hereunder which achieve the objects of the invention have not been shown in complete detail. Other embodiments may be developed without departing from the spirit of the invention or from the scope of the appended claims. Although the present invention has been described with respect to specific details, it is not intended that such details should be regarded as limitations on the scope of the invention, except to the extent that they are included in the accompanying claims.

We claim:

1. A method for hydraulic fracturing a well, comprising:
supplying a powdered water-soluble polymer selected to form slick water;
forming a mixture of powdered water-soluble additives for fracturing fluid;
forming a mixture of the powdered water-soluble additives and the powdered polymer to form a dry blend of polymer and additives;
adding the dry blend to water to form a fracturing fluid and pumping the fluid down a well.

2. The method of claim 1 wherein the dry blend contains at least 30 per cent by volume additives

3. The method of claim 1 wherein the water-soluble additives comprise a mixture of powdered biocide and clay stabilizer.

4. The method of claim 3 wherein the water-soluble additives further comprise a scale inhibitor, an oxygen scavenger or a surfactant.

5. The method of claim 1 wherein the water-soluble polymer is a polyacrylamide.

6. The method of claim 1 wherein adding the dry blend to water includes putting the dry blend in an eductor and flowing water past the eductor as a slip stream.

7. The method of claim 1 wherein the additives are selected to be approximately the same density.

8. The method of claim 1 wherein the additives are selected to be approximately the same particle size.

9. A mixture of solids for use in a hydraulic fracturing fluid, comprising:
a powdered water-soluble polymer selected to form slick water; and
a mixture of powdered water-soluble additives for fracturing fluid.

10. The mixture of claim 9 wherein the water-soluble additives consist of a biocide and a clay stabilizer.

11. The mixture of claim 10 wherein the biocide is Dazomet and the clay stabilizer is choline chloride.

12. The mixture of claim 9 wherein the powdered water-soluble polymer comprises a polyacrylamide.

13. The mixture of claim 9 wherein the water-soluble additives in the mixture are approximately the same density.

14. The mixture of claim 9 wherein the water-soluble additives in the mixture are approximately the same particle size.

15. The mixture of claim 10 further comprising a powdered additive selected from the group consisting of a scale inhibitor, an oxygen scavenger and a surfactant.

16. The mixture of claim 9 wherein, in the water-soluble additives, any oxygen scavenger has an LD₅₀ on rats greater than 2000, any scale inhibitor has an LD₅₀ greater than 5000 and any clay stabilizer has an LD₅₀ on rats greater than 100.
